(19) United States
(12) Patent Application Publication
(10) Pub. No.: US 2025/0217479 A1
(43) Pub. Date: Jul. 3, 2025

(54) SYSTEM AND METHOD FOR THREAT DETECTION AND PREVENTION

(71) Applicant: AMERICAN EXPRESS TRAVEL RELATED SERVICES COMPANY, INC., New York, NY (US)

(72) Inventor: Hiranmayi PALANKI, Tampa, FL (US)

(73) Assignee: AMERICAN EXPRESS TRAVEL RELATED SERVICES COMPANY, INC., New York, NY (US)

(21) Appl. No.: 18/400,997

(22) Filed: Dec. 29, 2023

(51) Int. Cl. G06F 21/55; G06N 20/20

(52) U.S. Cl. CPC G06F 21/552; G06N 20/20; G06F 2221/033

(57) ABSTRACT

Disclosed herein are apparatus, system, method, and computer-readable medium aspects for identifying and preventing digital skimming attacks using a machine learning model. A threat management system may crawl one or more external sources in order to obtain training data for one or more machine learning models. A plurality of different models may be used to conduct different analyses with respect to an application under test. For example, a first model may identify malicious code. A second model may detect the presence of threat protection code which may protect against skimming attacks. Depending on whether an application under test is free from malicious code and/or includes threat protection code, a threat management system may determine whether close may be promoted to a production or live environment. The threat management system may also use a third model to generate security protocol code for a developer based on learned best practices.

### BACKGROUND

### Field

Aspects of the present disclosure relate to components, systems, and methods for detecting and preventing digital security threats.

### Background

In today's electronic and online commerce markets, customers are often asked to provide payment and/or financial information, which is digitally processed and transmitted to one or more banks, credit card companies, or other financial institutions. At any point in this payment processing pipeline, as well as in development environments, malicious code may infiltrate these systems in order to maliciously obtain sensitive payment information and feed that information to bad actors.

### BRIEF SUMMARY

Disclosed herein are system, apparatus, device, method and/or computer program product embodiments, and/or combinations and sub-combinations thereof, for identifying malicious code, and for protecting against digital transaction intrusions and threats.

Aspects of the disclosure include a threat management system. The threat management system may provide digital skimming prevention. The threat management system may comprise a memory that stores training data and/or one or more vector databases. The memory may also store a plurality of promotion rules. The threat management system may also include at least one processor coupled to the memory. The at least one processor is configured to train a first machine learning model using the training data to identify malicious code and to train a second machine learning model using the training data to identify threat protection code. The at least one processor is further configured to analyze an application under test using the first machine learning model to determine a likelihood that the application under test includes malicious code and to analyze the application under test using the second machine learning model to determine a likelihood that the application under test includes threat protection code. Based on this analysis, the at least one processor promotes or denies promotion of the application under test based on the likelihood that the application under test includes malicious code, the likelihood that the application under test includes threat protection code, and the plurality of promotion rules.

### BRIEF DESCRIPTION OF THE DRAWINGS

The accompanying drawings are incorporated herein and form a part of the specification.

FIG. 1 illustrates a block diagram of an exemplary threat detection environment according to embodiments of the present disclosure.

FIG. 2 illustrates a block diagram of an exemplary threat management system according to embodiments of the present disclosure.

FIG. 3 illustrates a flow diagram illustrating a method for generating a digital skimming protection vector database according to embodiments of the present disclosure.

FIG. 4 illustrates a flow diagram illustrating a method for generating a script security protection vector database according to embodiments of the present disclosure.

FIG. 5 illustrates a flow diagram illustrating a method for preventing digital threats according to embodiments of the present disclosure.

FIG. 6 illustrates an exemplary method for determining whether an application under test includes malicious code or threat security protections according to embodiments of the present disclosure.

FIG. 7A illustrates an exemplary method for analyzing an application for malicious code according to embodiments of the present disclosure.

FIG. 7B illustrates an exemplary method for analyzing an application for sufficient security protocols to protect against malicious code according to embodiments of the present disclosure.

FIG. 8 illustrates a block diagram of an example computer system useful for implementing various embodiments.

In the drawings, like reference numbers generally indicate identical or similar elements. Additionally, generally, the left-most digit(s) of a reference number identifies the drawing in which the reference number first appears.

### DETAILED DESCRIPTION

Disclosed herein are system, apparatus, device, method and/or computer program product embodiments, and/or combinations and sub-combinations thereof, for identifying malicious code, and for protecting against digital transaction intrusions and threats.

In today's electronic and online commerce markets, customers are often asked to provide payment and/or financial information, which is digitally processed and transmitted to one or more banks, credit card companies, or other financial institutions. At any point in this payment processing pipeline, as well as in development environments, malicious code may infiltrate these systems in order to maliciously obtain sensitive payment information and feed that information to bad actors.

One such payment intrusion software is known as a Magecart attack. Magecart is a type of cyberattack that targets online businesses with the goal of stealing sensitive information, such as payment card data. These attacks are a form of web skimming. Web skimming or digital skimming may refer to leveraging third-party vulnerabilities in ecommerce and other e-service platforms to inject malicious code into an online retailer's payment pages. This may be performed within a web browser in order to skim for sensitive personal and/or financial information. The malicious code captures payment card details entered by a site visitor during the checkout process and sends it to an attacker-controlled domain for harvesting.

While this is one type of a malicious skimming application, other skimmers perform similar functions with respect to payment or other sensitive information. Current detection solutions struggle to adequately identify these skimmers because they tend to occur within the browser. The malicious code may also be hidden within legitimate code on the retailer's website. This may pose an additional complication for a financial institution facilitating a transaction, since the malicious code may reside at a third-party's website which is out of the institution's control.

To address these issues, described herein is a threat management system that detects and prevents digital commerce threats. The threat management system is able to detect these threats on third-party systems and/or protect against these threats remotely. For example, the threat management system may use large language models (LLMs) along with vector databases to identify malicious code. For example, the LLMs may compare vector representations of code to vector embeddings corresponding to digital skimmer scripts to identify potential similarities. In response to detecting potential digital skimming code, the threat management system may prevent such code from being implemented and/or generate an alert identifying that malicious code has been detected.

Similarly, the threat management system may also detect whether threat protection code has been implemented. This threat protection code may include code that guards against and/or protects against digital skimming attacks. The LLMs may also compare vector representations of code to vector embeddings corresponding to threat protection code to identify potential similarities. In some embodiments, threat management system may prevent code that lacks sufficient threat prevention code and/or protocols from being implemented in a production environment. Similarly, the threat management system may also generate an alert indicating a lack of threat protection code.

In some embodiments, the threat management system may also use the LLMs to identify and/or suggest exemplary code. This code may be identified as code that may be used to guard against skimming attacks and/or other security threats. In some embodiments, the threat management system may identify code reflecting best practices for guarding against such attacks. The threat management system may use the LLM to identify such code based on other code that has been implemented in a production environment. The threat management system may then suggest such code to developers for implementation and/or provide code edits or suggestions to developers to protect against digital skimming attacks.

Various embodiments of these features will now be discussed with respect to the corresponding figures.

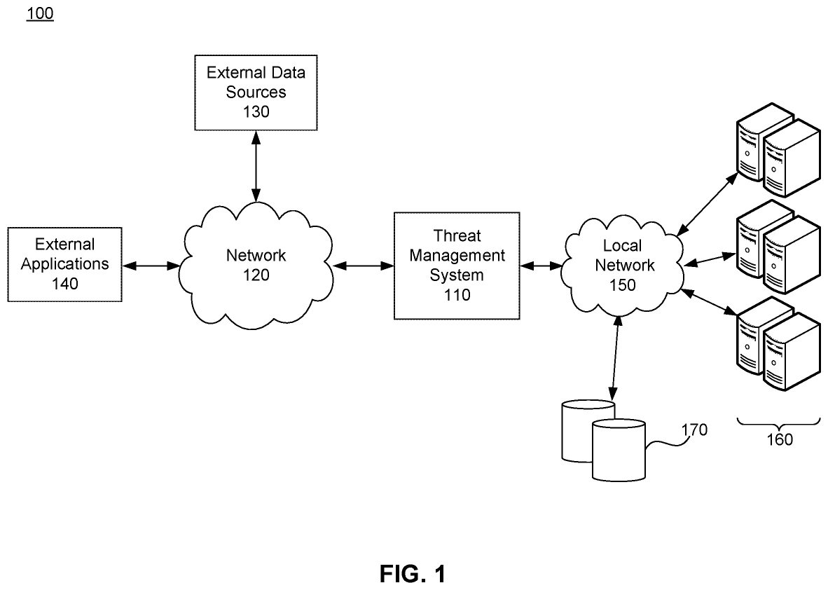

FIG. 1 illustrates a block diagram of an exemplary threat detection environment 100 according to embodiments of the present disclosure. As shown in FIG. 1, the environment 100 includes a threat management system 110 that performs threat detection and prevention analysis, as will be discussed below. Environment 100 includes threat management system 110, network 120, external data sources 130, external applications 140, local network 150, development servers 160, and/or databases 170.

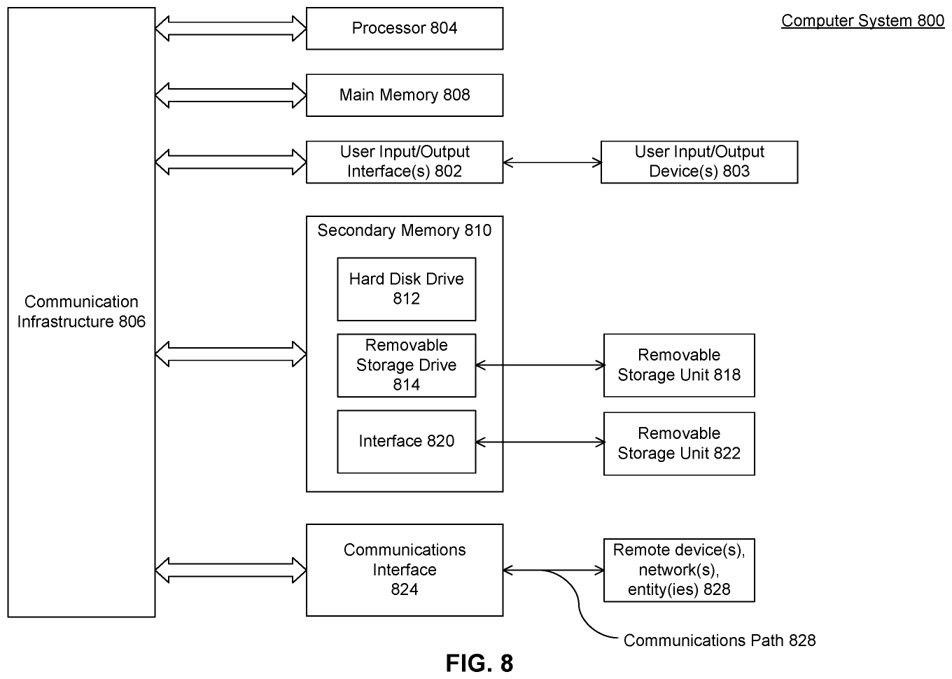

Threat management system 110 may be implemented using one or more servers and/or databases. Threat management system 110 may further include one or more operating systems and/or may be implemented as part of an enterprise computing platform and/or a cloud computing platform. Threat management system 110 may also be implemented using one or more servers and/or databases and/or computer system 800 described with reference to FIG. 8.

The threat management system 110 may include one or more machine learning models and/or artificial intelligence models for performing various threat analyses. In an embodiment, the threat management system 110 includes a first model configured for detecting malicious scripts running at various levels of the financial payment pipeline, a second model configured to verify that new code includes certain security measures for preventing security threats prior to entering production, and/or a third model which can be fine-tuned for thwarting these attacks. In embodiments, the various models operated by the threat management system 110 are large language models (LLMs). LLMs may refer to artificial intelligence algorithms that use deep learning techniques and massively large data sets in order to understand, summarize, generate, and predict new content. In embodiments, other types of analysis models may be used.

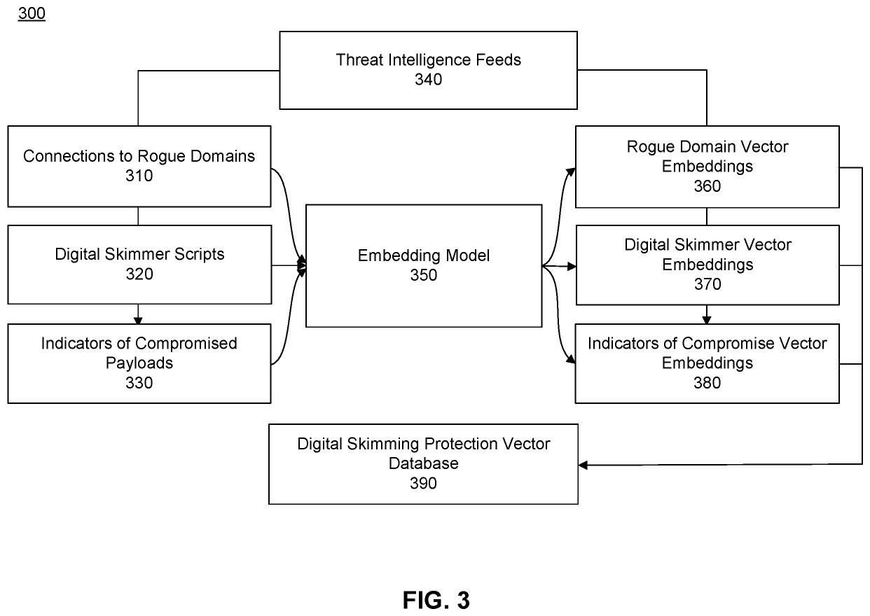

To operate these models, threat management system 110 may crawl external data sources 130 to obtain source code and/or vectors used to build the databases on which the LLMs operate. Threat management system 110 may access external data sources 130 and/or external applications 140 via network 120. In embodiments, external data sources 130 may include threat intelligence feeds, which may accumulate knowledge of Magecart and other similar malicious software. The threat intelligence feeds may be threat intelligence feeds 340 as further described with reference to FIG. 3. This may include samples of malicious code and/or information relating to their behavior, code appearance, etc. Similarly, the external applications 140 may include applications from third-parties and/or owned by financial institutions that have gone into production. Threat management system 110 may use the information obtained from these sources to generate databases and/or training datasets for use by the LLMs. For example, malicious code and/or text corresponding to the code may be stored and/or used to train the LLMs to detect similar malicious code.

In embodiments, the information obtained from the external data sources 130 and/or external applications 140 is loaded into one or more databases 170 located on a local network 150. In an embodiment, the local network 150 may provide and/or facilitate an enterprise computing system. Local network 150 may supports computing systems connected to the enterprise computing system and/or threat management system 110. In some embodiments, the enterprise computing system may be operated by an organization, such as a bank, credit card company, or other financial institution. In an embodiment, the threat management system 110 may review and/or analyze code, programming, and/or applications produced at one or more development servers 160, as will be discussed in further detail below. Development servers 160 may also be a part of the enterprise computing system and/or communicate with threat management system 110 via local network 150.

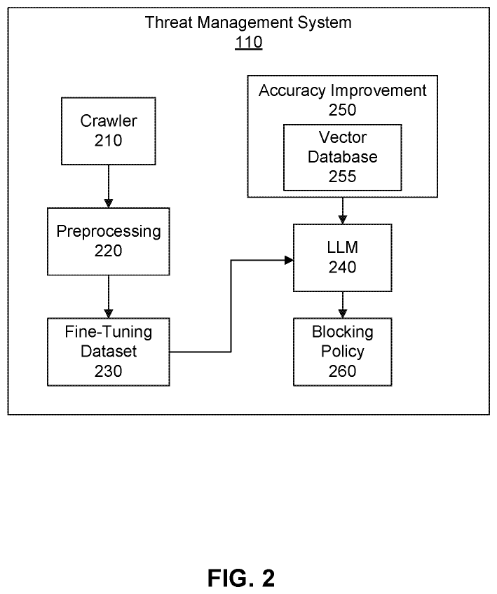

FIG. 2 illustrates a block diagram of an exemplary threat management system 110 according to embodiments of the present disclosure. Threat management system 110 may represent an exemplary embodiment of threat management system 110 as described with reference to FIG. 1. As shown in FIG. 2, the threat management system 110 includes a crawler 210, a preprocessing block 220, a fine-tuning dataset 230, an LLM 240, an accuracy improvement block 250, and/or a blocking policy 260. These components may provide threat detection and/or threat prevention as described herein.

As shown in FIG. 2, a crawler 210 crawls, scans, and/or checks for updated content on one or more external data sources. In some embodiments, the one or more external data sources may be external data sources 130 as described with reference to FIG. 1. The content may include samples of malicious code and/or vectors corresponding to malicious code. The data obtained from the crawling operation is then preprocessed at preprocessing block 220. Preprocessing block 220 may format the received data so that it is uniform. For example, this may include parsing and/or formatting code samples. This data may then be added to a fine-tuning dataset 230. In an embodiment, the fine-tuning dataset 230 is used to train, re-train, and/or update the LLM 240.

In an embodiment, accuracy improvement block 250 utilizes a vector database 255 in order to reduce potential errors and hallucinations, including false positives. In an embodiment, the vector database 255 may store vectors corresponding to malicious code. Accuracy improvement block 250 may operate on an embeddings model and/or nearest neighbor calculations, which may root out false positives and other errors.

Based on the fine-tuning dataset 230, and the accuracy improvement block 250, the LLM 240 analyzes a particular application for a malicious application and/or malicious code running thereon. As a result of the analysis, the LLM 240 outputs a resulting probability value indicative of the likelihood that a target has been identified within the analyzed application or code. This result is then provided to a blocking policy 260, which makes a determination based on one or more rules contained therein, whether the analyzed code or application is considered safe or unsafe.

To implement this threat detection and prevention, threat management system 110 may use one or more machine learning models. As discussed above, one model included within threat management system 110 is a digital skimming detection model. The LLM 240 may implement the digital skimming detection model. In this embodiment, the crawler 210 crawls known threat intelligence feeds, which maintain and/or store knowledge relating to digital skimming applications, such as Magecart, as well as other known external sources of information relating to digital skimming formats, detection, functionality, etc. The threat intelligence feeds may be threat intelligence feeds 340 as further described with reference to FIG. 3. From this data crawling operation, the crawler 210 may obtain rogue domains to which skimmed data is forwarded for harvesting; skimmer scripts for demonstrative format and functionality of skimmer applications; and/or indicators of compromise, which are factors that evidence that a script is harmful.

This information is the provided to the preprocessing block 220 for preprocessing before being added to the fine-tuning dataset 230 used to train the LLM 240. The LLM 240 is then provided with a script or application under test that is to be analyzed for malicious code. Using the training data and the vector database 255, the LLM 240 calculates a likelihood or probability that the script or application under test includes malicious code. The blocking policy 260 then analyzes this result to determine whether the script under test is to be blocked. In an embodiment, the script under test is located at one or more development servers 160. In this case, the blocking policy 260 determines whether the script is ready for use in a live or production environment.

As discussed above, the second LLM may be a script security protection LLM. LLM 240 may implement a script security protection LLM. In this configuration, the crawler 210 crawls web applications in production. In embodiments, this may include web applications and/or web pages from a first party and/or third parties. In an embodiment, the crawler 210 may obtain content security policies that are built into browsers; sub-resource integrity checks for JavaScript to prevent against tampering; and/or security headers (such as HTTP security headers) to prevent leakage to rogue domains.

The obtained information is then preprocessed in order to format and normalize the data for use in training of the LLM 240. The preprocessed data may be stored in the fine-tuning dataset 230 for training the LLM 240. LLM 240 may then be provided with an application under test. In embodiments, the application to be tested may be a first party or third party application. Using the training data and the vector database 255, the LLM 240 calculates a likelihood that a particular application includes sufficient script security measures to prevent a malicious infiltration. The blocking policy 260 then analyzes this result to determine whether the application should be blocked. In an embodiment where the application under test is already in production, the blocking policy 260 determines whether the application should be pulled from production for modification. Alternatively, for an application under test that is in development, the blocking policy 260 determines whether the application should be withheld from moving to production.

Although each of the above LLMs has been described separately, it should be understood that the threat management system 110 may implement each of these LLMs using LLM 240. In some embodiments, the LLMs may be implemented in parallel, with each having a configuration as shown in FIG. 2.

In some embodiments, threat management system 110 may execute a first LLM configured to determine a likelihood that an application under test includes malicious code; execute a second LLM configured to determine a sufficiency of threat security protections in place in the application under test; and execute a third LLM configured to thwart digital skimming threats,

FIG. 3 illustrates a flow diagram illustrating a method 300 for generating a digital skimming protection vector database according to embodiments of the present disclosure. Method 300 may be implemented by threat management system 110 as described with reference to FIG. 1 and/or FIG. 2. Threat management system 110 may use elements of method 300 to generate vector database 255 and/or to update vector database 255 with vectors corresponding to digital skimming scripts.

In the embodiment of FIG. 3, a digital skimming detection vector database is generated for supporting the digital skimming detection model LLM. Threat management system 110 may implement and/or execute method 300 to generate vector database 255. For example, crawler 210 may crawl threat intelligence feeds 340 to obtain information relating to threats and/or threat data. Threat intelligence feeds 340 may include repositories and/or sources of data that provide information related to Magecart attacks and other similar malicious software. In some embodiments, the threat intelligence feeds 340 may be received externally from threat management system 110. The data received from threat intelligence feeds 340 may include samples of malicious code and/or information relating to their behavior, code appearance, etc. The threat intelligence feeds 340 may also include connections to rogue domains 310; digital skimmer scripts 320; and/or indicators of compromised payloads 330. Threat management system 110 may apply this data to embedding model 350, which computes corresponding vector embeddings. The vector embeddings may include rogue domain vector embeddings 360, digital skimmer vector embeddings 370, and indicators of compromise vector embeddings 380. Threat management system 110 may store vector embeddings 360, 370, and/or 380 in digital skimming protection vector database 390. Digital skimming protection vector database 390 may be an exemplary embodiment of vector database 255 as described with reference to FIG. 2.

In some embodiments, whereas some script analysis systems use a binary decision-making process to determine whether a given script is malicious, threat management system 110 and/or embeddings model 350 may use vector embeddings 360, 370, and 380 to determine whether a particular script under test is malicious. For example, threat management system 110 may use LLM 240 and/or perform cosine similarity analysis between known malicious scripts and those under test to identify scripts that may be malicious. In some embodiments, this analysis may be performed without the need for text of the script to match or for text to be the same or similar as the known malicious script. Instead, threat management system 110 may use LLM 240 to determine whether a vector representation of a script under test is similar to vector embeddings 360, 370, and 380. A similarity may indicate that the script under test includes malicious code.

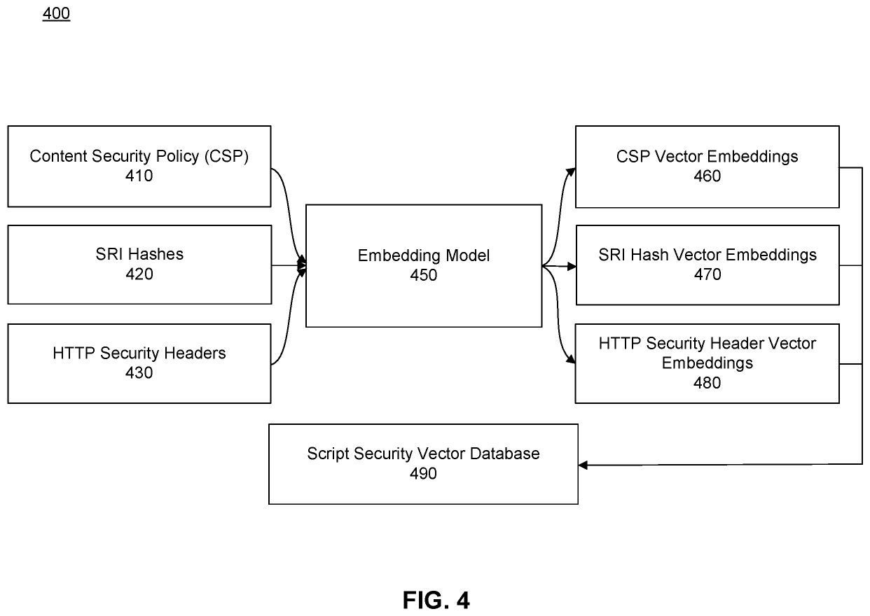

FIG. 4 illustrates a flow diagram illustrating a method 400 for generating a script security protection vector database according to embodiments of the present disclosure. Method 400 may be implemented by threat management system 110 as described with reference to FIG. 1 and/or FIG. 2. Threat management system 110 may use elements of method 400 to generate vector database 255 and/or to update vector database 255 with vectors corresponding to scripts that include security protections.

In the embodiment of FIG. 4, a script security protection vector database is generated for supporting a security protection model LLM. Threat management system 110 may implement and/or execute method 400 to generate vector database 255. For example, crawler 210 may crawl one or more external sources, such as production web pages or servers to obtain information relating to content security policies (CSPs) 410, sub-resource integrity (SRI) hashes 420, and/or HTTP security headers 430. Threat management system 110 may apply this data to the embedding model 450, which computes the corresponding vector embeddings. The embeddings may include CSP vector embeddings 460, SRI hash vector embeddings 470, and HTTP security header vector embeddings 480. Threat management system 110 may store vector embeddings 460, 470, and/or 480 in script security vector database 490. Script security vector database 490 may be an exemplary embodiment of vector database 255 as described with reference to FIG. 2.

As described with reference to FIG. 2, LLM 240 may use vector embeddings 460, 470, and/or 480 to determine whether software under test includes security code or programming that guards against malicious software or attacks. Threat management system 110 may determine whether a vector version of the code includes a vector similar to vector embeddings 460, 470, and 480 as stored in script security vector database 490. For example, threat management system 110 may use LLM 240 and/or the embedding model 450 to perform cosine similarity between code under test and known security measures employed to protect against Magecart and other similar malicious software. By using this comparison, threat management system 110 may determine whether such protections have been implemented in the code or software under test. If so, threat management system 110 may allow the code or software to proceed to a live version or to a production environment. If not, threat management system 110 may prevent the code or software from proceeding to the live version or the production environment. Threat management system 110 may also generate an alert instructing a software developer to implement such protections and/or safeguards into the code.

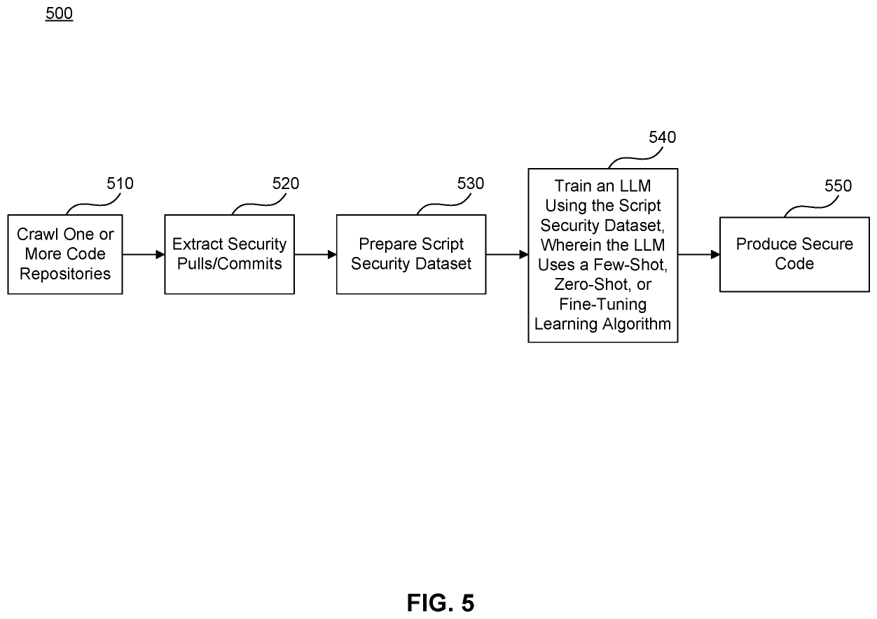

FIG. 5 illustrates a flow diagram illustrating a method 500 for preventing digital threats according to embodiments of the present disclosure. As discussed above, threat management system 110 may include up to three different LLMs that are each configured for carrying out a different security analysis. LLM 240 may implement these LLM techniques. As described with reference to FIG. 2, threat management system 110 may include LLM 240 which may be a fine-tuned for thwarting web skimming threats to the payment industry. For example, LLM 240 may be fine-tuned to thwart Magecart attacks. In some embodiments, LLM 240 may be a codex LLM. Method 500 may be implemented by threat management system 110 as described with reference to FIG. 1 and/or FIG. 2. Threat management system 110 may use elements of method 500 to prevent digital threats.

Threat management system 110 may implement and/or execute method 500 to identify code that includes security protections against skimming attacks. This may include detecting code that includes such security protections and/or modifying code under test so that the code under test includes the security protections. In some embodiments, threat management system 110 may identify code and/or code features that include web skimming protections by analyzing other code that has been committed to a repository and/or that is in production use. As previously explained, threat management system 110 may include a code crawler 210 and/or an LLM 240 having a number of different training options. Threat management system 110 may utilize these components when implementing and/or executing method 500.

At 510, threat management system 110 may use code crawler 210 to crawl one or more code repositories. In some embodiments, the one or more code repositories may be internal code sources, such as first party code repositories. This crawling may identify code and/or portions of code from the repositories. As further explained below, this may include code that guards against security threats. At 520, threat management system 110 may extract security pulls and/or commits made to the repository. For example, this may include identifying code stored and/or retrieved from the repository. At 530, threat management system 110 may prepare a script security dataset. The script security dataset may correspond to and/or indicate code that includes protections against skimming attacks. Using this information and/or code, threat management system 110 may identify code and/or code features that guard against Magecart and other security threats. In some embodiments, best coding practices in terms of Magecart and other threat security can be identified for future coding operations.

At 540, threat management system 110 may train LLM 240 using the script security dataset. The script security dataset may be used to train and/or re-train LLM 240 to identify and/or suggest code that includes such best practices. Threat management system 110 may also use LLM 240 to modify code so that the code includes code features that include these protections. LLM 240 may use and/or be configured to use one or more of a few-shot learning algorithm, a zero-shot learning algorithm, and/or a fine-tuning learning algorithm. The few-shot learning algorithm may be used to generate a prediction based on a limited number of samples. The few-shot learning algorithm may be an example of meta-learning, where the LLM 240 is trained on several related tasks, during the meta-training phase, so that it can generalize tasks with just a few examples, during the meta-testing phase. For example, this may be used to identify and/or suggest code features and/or code edits that include security protections from a sample of code features that include such protections. LLM 240 may also use a zero-shot learning algorithm. In this case, LLM 240 may observe samples from classes which were not observed during training. LLM 240 may predict the class that they belong to. For example, this may be used to predict and/or identify code features including security protections even when corresponding examples were not explicitly used to train LLM 240. LLM 240 may also use the fine-tuning algorithm to perform such predictions as well. The fine-tuning algorithm may be used to transfer learning in which weights of a pre-trained model are trained on new data. Using one or more of these learning techniques, the LLM 240 may identify code and/or code features corresponding to best practices for coding software to prevent financial skimming attacks.

At 550, threat management system 110 may produce secure code. As a result of the training at 540, the LLM 240 may output the secure code to be used in one or more applications. This secure code may include text and/or code that may be viewable by a developer. In some embodiments, LLM 240 may provide edits to code, which may reflect the code features identified based on training. Developers may use the secure code and/or secure code suggestions to ensure that the developer's code includes protections against digital skimming attacks and/or Magecart attacks.

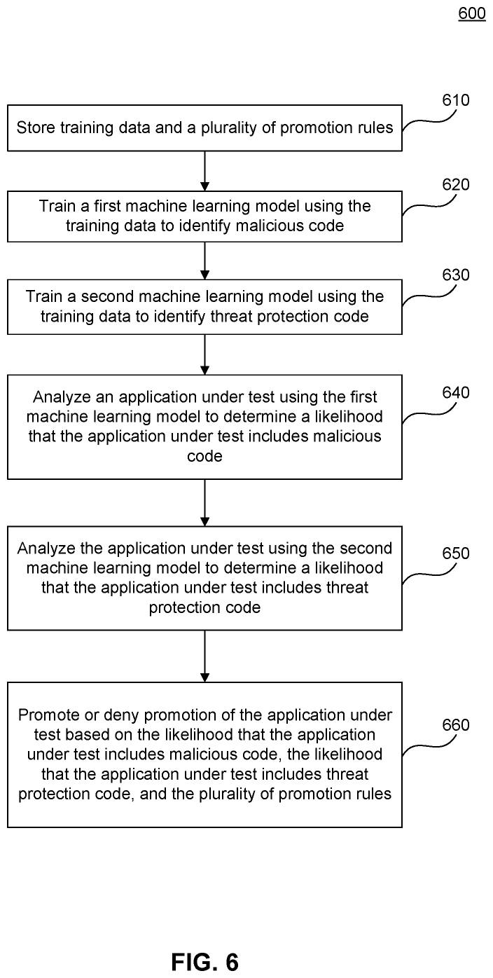

FIG. 6 illustrates an exemplary method 600 for determining whether an application under test includes malicious code or threat security protections according to embodiments of the present disclosure. Method 600 shall be described with reference to FIG. 1 and FIG. 2; however, method 600 is not limited to that example embodiment.

In an embodiment, threat management system 110 may utilize method 600 to detect whether an application under test includes malicious code and/or lacks threat protection code. In either of these cases, threat management system 110 may prevent the promotion of the application under test to a production environment. This may prevent the application under test from being promoted to and/or implanted in a live or production version of software. The foregoing description will describe an embodiment of the execution of method 600 with respect to threat management system 110. While method 600 is described with reference to threat management system 110, method 600 may be executed on any computing device, such as, for example, the computer system described with reference to FIG. 8 and/or processing logic that may comprise hardware (e.g., circuitry, dedicated logic, programmable logic, microcode, etc.), software (e.g., instructions executing on a processing device), or a combination thereof.

It is to be appreciated that not all steps may be needed to perform the disclosure provided herein. Further, some of the steps may be performed simultaneously, or in a different order than shown in FIG. 6.

At 610, threat management system 110 stores training data and a plurality of promotion rules. For example, as described with reference to FIG. 2, threat management system 110 may crawl one or more sources of training data. The one or more sources may include code repositories managed by threat management system 110, repositories external to threat management system 110, external data sources 130, and/or external applications 140. This training data may include samples of malicious code and/or vectors corresponding to malicious code. The training data may also include threat protection code. The threat protection code may be code that includes security protections and/or code that guards against digital skimming attacks. Threat management system 110 may gather these code examples for training of LLMs to detect similar code features from applications under test. In some embodiments, the training data may be transformed and/or stored as vector embeddings. This may occur in a manner similar to the processes described with reference to FIG. 3 and FIG. 4. For example, threat management system 110 may store the training data as vectors in one or more vector databases.

The plurality of promotion rules may refer to thresholds and/or programming used by threat management system 110 to determine whether to promote examined code to a production or live environment or to prevent the code or software from proceeding to the live version or the production environment. As explained herein, the plurality of promotion rules may include thresholds used to manage code based on a probability that an LLM (e.g., LLM 240) detects malicious code and/or threat protection code. For example, the plurality of promotion rules may permit promotion of an application under test to a production environment if a probability that the application under test includes malicious code is below a threshold and/or a probability that the application under test includes threat protection code is above a threshold. These thresholds and/or rules may be varied. For example, this may be adjusted by an administrator of threat management system 110.

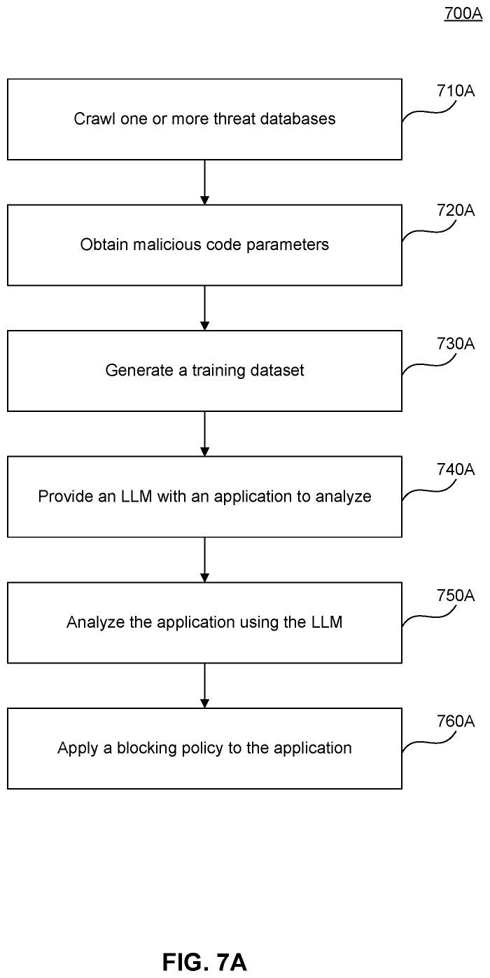

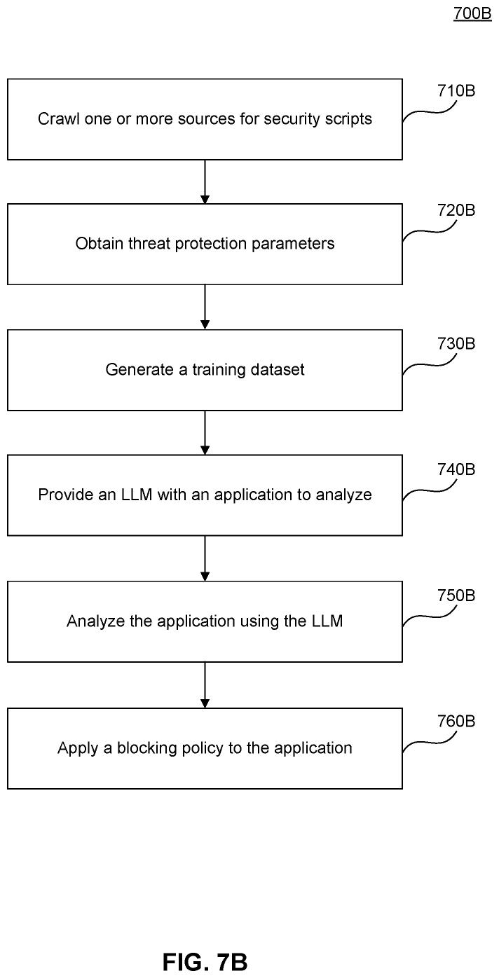

At 620, threat management system 110 trains a first machine learning model using the training data to identify malicious code. This may occur in the manner described with reference to FIG. 2 and/or FIG. 7A. LLM 240 may implement the first machine learning model. For example, threat management system 110 may train LLM 240 to detect code and/or code features similar to code that includes digital skimming functionality as identified by the training data. LLM 240 may be trained to generate a likelihood and/or a probability value that code under test includes malicious code based on this training. In some embodiments, this value may be generated using a cosine similarity analysis between code under test and/or vectors corresponding to the malicious code examples. In this manner, threat management system 110 may analyze text from code, software, programming, and/or applications to determine whether such code includes malicious code.

At 630, threat management system 110 trains a second machine learning model using the training data to identify threat protection code. This may occur in the manner described with reference to FIG. 2 and/or FIG. 7B. LLM 240 may implement the second machine learning model. For example, threat management system 110 may train LLM 240 to detect code and/or code features similar to code that provides protections against digital skimming attacks. Such code features may be desirable to include in code that may be used in a live or production environment. LLM 240 may be trained to generate a likelihood and/or a probability value that code under test includes threat protection code based on this training. In some embodiments, this value may be generated using a cosine similarity analysis between code under test and/or vectors corresponding to the threat protection code examples. In this manner, threat management system 110 may analyze text from code, software, programming, and/or applications to determine whether such code includes threat protection code. As described herein, LLM 240 may implement the first and/or the second machine learning model. In some embodiments, threat management system 110 may include one or more LLMs 240 configured to implement the first and/or the second machine learning model.

At 640, threat management system 110 analyzes an application under test using the first machine learning model to determine a likelihood that the application under test includes malicious code. In some embodiments, the application under test is in development and/or is located on a development server. In some embodiments, the application under test is in production and/or may be located on an application server. After model training, threat management system 110 may be used to analyze code and/or applications to determine whether such code or applications under test include malicious code. If so, threat management system 110 may prevent the promotion and/or proliferation of such code. This may be a mechanism for guarding against the introduction of malicious code and/or digital skimming code. In some embodiments, upon analyzing the text of the code and/or application, threat management system 110 may generate a likelihood and/or probability value that the malicious code has been detected.

At 650, threat management system 110 analyzes the application under test using the second machine learning model to determine a likelihood that the application under test includes threat protection code. After model training, threat management system 110 may be used to analyze code and/or applications to determine whether such code or applications under test include threat protection code. If the code does not include such protections, threat management system 110 may prevent the promotion and/or proliferation of such code. This may be a mechanism for ensuring that production code or applications include mechanisms to guard against digital skimming attacks. In some embodiments, upon analyzing the text of the code and/or application, threat management system 110 may generate a likelihood and/or probability value that threat protection code is included.

At 660, threat management system 110 promotes or denies promotion of the application under test based on the likelihood that the application under test includes malicious code, the likelihood that the application under test includes threat protection code, and the plurality of promotion rules. For example, threat management system 110 may determine whether the application under test is to be promoted to a production status based on the plurality of promotion rules. As previously explained, the plurality of promotion rules may include one or more parameters or thresholds indicating one or more actions corresponding to the detected probabilities. For example, if the likelihood that the application under test includes malicious code exceeds a particular threshold, threat management system 110 may deny the application under test from promotion. This may include preventing the application and/or code from being committed to a repository. In some embodiments, threat management system 110 may also generate an alert to a software developer and/or administrator indicating that malicious code has been detected.

Threat management system 110 may also use the likelihood that the application under test includes threat protection code to determine a corresponding action. For example, if the likelihood that the application under test includes threat protection code does not meet or falls below a particular threshold, threat management system 110 may deny the application under test from promotion. This may include preventing the application and/or code from being committed to a repository. In some embodiments, threat management system 110 may also generate an alert to a software developer and/or administrator indicating that the code or application does not include threat protection code.

In some embodiments, threat management system 110 may permit the promotion of code or an application to a production environment and/or a live environment if a likelihood of malicious code is low and a likelihood of threat protection code is high. For example, this may occur when the likelihood of malicious code falls below a threshold while the likelihood of threat protection code exceeds a threshold. Threat management system 110 may modify these thresholds, conditions, and/or rules based on administrator instructions and/or commands.

As further explained below, method 600 may also implement elements for method 700A and method 700B as described with reference to FIG. 7A and FIG. 7B respectively. For example, method 600 may also implement blocking rules to prevent code from entering a production environment and/or to remove code from a production environment. The blocking rules may also indicate whether to disable and/or block the application under test.

FIG. 7A illustrates an exemplary method 700A for analyzing an application for malicious code according to embodiments of the present disclosure. Method 700A shall be described with reference to FIG. 1, FIG. 2, and FIG. 3; however, method 700A is not limited to that example embodiment.

In an embodiment, threat management system 110 may utilize method 700A to detect and/or block malicious code. The foregoing description will describe an embodiment of the execution of method 700A with respect to threat management system 110. While method 700A is described with reference to threat management system 110, method 700A may be executed on any computing device, such as, for example, the computer system described with reference to FIG. 8 and/or processing logic that may comprise hardware (e.g., circuitry, dedicated logic, programmable logic, microcode, etc.), software (e.g., instructions executing on a processing device), or a combination thereof.

It is to be appreciated that not all steps may be needed to perform the disclosure provided herein. Further, some of the steps may be performed simultaneously, or in a different order than shown in FIG. 7A.

At 710A, threat management system 110 crawls one or more threat databases. This may be done in the manner described with reference to method 300 and FIG. 3. Threat management system 110 may use a crawler 210 that crawls certain external data sources for information relevant to the analysis. For example, these may include external data sources 130. In embodiments, these external data sources 130 include known threat intelligence feeds 340, which maintain and/or store knowledge relating to digital skimming applications, such as Magecart, as well as other known external sources of information relating to digital skimming formats, detection, functionality, etc.

At 720A, the crawler 210 obtains malicious code parameters from those external data sources 130, which may include 1) known rogue domains to which skimmed data is forwarded for harvesting; 2) known skimmer scripts for demonstrative format and functionality of skimmer applications; and 3) indicators of compromise, which are factors that evidence that a script is harmful. In embodiments, this information is formatted for appropriate storage.

At 730A, the obtained data is used to generate a training dataset. As explained with reference to FIG. 1 and FIG. 2, the training dataset may include samples of malicious code and/or information relating to their behavior, code appearance, etc. In some embodiments, the training dataset may include fine-tuning dataset 230 and/or vector database 255. Preprocessing block 220 may format the received data so that it is uniform and/or to generate the training dataset. In embodiment, the training dataset is used by a machine learning model, such as LLM 240, in order to identify indicators of a malicious script present in an application or code.

At 740A, LLM 240 is provided with an application to analyze. In some embodiments, the application is an application in development awaiting promotion to production. For example, prior to promoting the application to a production environment, a software developer may provide the application to threat management system 110 for analysis. Threat management system 110 may be implemented within an enterprise computing system. A software developer system may provide the application by accessing threat management system 110 via an API and/or a graphical user interface. In some embodiments, threat management system 110 may provide an application analysis for a third-party system. Threat management system 110 may receive the application from the third-party system via an API communication. Upon receiving the application, threat management system 110 may provide the application code to LLM 240.

At 750A, LLM 240 analyzes the application under test using the training obtained from the training dataset. As explained with reference to FIG. 1 and FIG. 2, LLM 240 may have been trained to detect malicious code using the training dataset. For example, LLM 240 may have been trained to identify text from source code that includes malicious code. When analyzing the application under test, LLM 240 may determine and/or detect whether the application includes language and/or text that includes malicious code. In an embodiment, the analysis will output a probability that the application under test includes malicious code.

At 760A, a blocking policy 260 is applied to the application based on the output probability. In embodiments, the blocking policy 260 includes a plurality of rules that are applied to the application based on the results of the analysis performed by LLM 240. Based on the applied blocking policy 260, the application under test is either promoted to production, or an alert or other report is generated to inform a developer as to the presence of the malicious code. In an embodiment, the report includes a listing of the indicators detected by LLM 240.

FIG. 7B illustrates an exemplary method for analyzing an application for sufficient security protocols to protect against malicious code according to embodiments of the present disclosure. Method 700B shall be described with reference to FIG. 1, FIG. 2, and FIG. 3; however, method 700B is not limited to that example embodiment.

In an embodiment, threat management system 110 may utilize method 700B to detect whether code implements security protocols and/or threat protection code. The foregoing description will describe an embodiment of the execution of method 700B with respect to threat management system 110. While method 700B is described with reference to threat management system 110, method 700B may be executed on any computing device, such as, for example, the computer system described with reference to FIG. 8 and/or processing logic that may comprise hardware (e.g., circuitry, dedicated logic, programmable logic, microcode, etc.), software (e.g., instructions executing on a processing device), or a combination thereof.

It is to be appreciated that not all steps may be needed to perform the disclosure provided herein. Further, some of the steps may be performed simultaneously, or in a different order than shown in FIG. 7B.

At 710B, threat management system 110 crawls one or more sources for security scripts. The sources may include production applications. This may be done in the manner described with reference to method 400 and FIG. 4. Threat management system 110 may use crawler 210 to crawl certain external data sources for information relevant to the analysis. For example, these may include external data sources 130. In embodiments, these external data sources 130 include web applications from both a first party and third parties, whereas in other embodiments, these web pages only include first party applications.

At 720B, crawler 210 obtains examples of threat protection parameters from those external sources 130, which in this embodiment, may include 1) content security policies that are built into browsers; 2) sub-resource integrity checks for JavaScript to prevent against tampering; and 3) a variety of security headers (such as HTTP security headers) to prevent leakage to rogue domains. This may be done in the manner described with reference to method 400 and FIG. 4. In embodiments, the threat protection parameter information is formatted for appropriate storage.

At 730B, the obtained data is used to generate a training dataset. As explained with reference to FIG. 1 and FIG. 2, the training dataset may include samples of code with security protections. In some embodiments, the training dataset may include fine-tuning dataset 230 and/or vector database 255. Preprocessing block 220 may format the received data so that it is uniform and/or to generate the training dataset. In embodiment, the training dataset is used by a machine learning model, such as LLM 240, in order to identify whether certain applications have sufficient threat prevention mechanisms and security protocols in place.

At 740B, LLM 240 is provided with an application to analyze. In an embodiment, the application is an application in production. In embodiments, the application is owned and/or operated by a third party, whereas in other embodiments, the application is a first party application. For example, prior to promoting the application to a production environment, a software developer may provide the application to threat management system 110 for analysis. Threat management system 110 may be implemented within an enterprise computing system. A software developer system may provide the application by accessing threat management system 110 via an API and/or a graphical user interface. In some embodiments, threat management system 110 may provide an application analysis for a third-party system. Threat management system 110 may receive the application from the third-party system via an API communication. Upon receiving the application, threat management system 110 may provide the application code to LLM 240.

At 750B, LLM 240 analyzes the application under test using the training obtained from the training dataset. As explained with reference to FIG. 1 and FIG. 2, LLM 240 may have been trained to detect secure code and/or threat prevention code using the training dataset. For example, LLM 240 may have been trained to identify text from source code that includes such security measures. When analyzing the application under test, LLM 240 may determine and/or detect whether the application includes language and/or text that includes this secure code. In an embodiment, the analysis will output a probability that the application includes sufficient security and/or threat prevention protocols to thwart against skimming attacks.

At 760B, a blocking policy 260 is applied to the application based on the output probability. In embodiments, the blocking policy 260 includes a plurality of rules that are applied to the application based on the results of the analysis. Based on the applied blocking policy 260, if the application is already in production, then threat management system 110 makes a determination as to whether the application should be disabled and/or pulled from production. On the other hand, if the application is in development, then the threat management system 110 makes a determination as to whether the application under test is either promoted to production, or an alert or other report is generated to inform a developer as to the lack of sufficient security and/or threat prevention protocols present in the code. In an embodiment, the report includes a listing of the security protocols included and absent from the application under test.

It should be understood that, unless a later step relies on an earlier step for completion, the steps can be rearranged within the spirit and scope of the present disclosure. Also, the methods 600, 700A, and 700B described above can include more or fewer steps than those illustrated, which are provided as an example embodiment.

Various embodiments may be implemented, for example, using one or more well-known computer systems, such as computer system 800 shown in FIG. 8. One or more computer systems 800 may be used, for example, to implement any of the embodiments discussed herein, as well as combinations and sub-combinations thereof.

Computer system 800 may include one or more processors (also called central processing units, or CPUs), such as a processor 804. Processor 804 may be connected to a communication infrastructure or bus 806.

Computer system 800 may also include user input/output device(s) 803, such as monitors, keyboards, pointing devices, etc., which may communicate with communication infrastructure 806 through user input/output interface(s) 802.

One or more of processors 804 may be a graphics processing unit (GPU). In an embodiment, a GPU may be a processor that is a specialized electronic circuit designed to process mathematically intensive applications. The GPU may have a parallel structure that is efficient for parallel processing of large blocks of data, such as mathematically intensive data common to computer graphics applications, images, videos, etc.

Computer system 800 may also include a main or primary memory 808, such as random access memory (RAM). Main memory 808 may include one or more levels of cache. Main memory 808 may have stored therein control logic (i.e., computer software) and/or data.

Computer system 800 may also include one or more secondary storage devices or memory 810. Secondary memory 810 may include, for example, a hard disk drive 812 and/or a removable storage device or drive 814. Removable storage drive 814 may be a floppy disk drive, a magnetic tape drive, a compact disk drive, an optical storage device, tape backup device, and/or any other storage device/drive.

Removable storage drive 814 may interact with a removable storage unit 818. Removable storage unit 818 may include a computer usable or readable storage device having stored thereon computer software (control logic) and/or data. Removable storage unit 818 may be a floppy disk, magnetic tape, compact disk, DVD, optical storage disk, and/any other computer data storage device. Removable storage drive 814 may read from and/or write to removable storage unit 818.

Secondary memory 810 may include other means, devices, components, instrumentalities or other approaches for allowing computer programs and/or other instructions and/or data to be accessed by computer system 800. Such means, devices, components, instrumentalities or other approaches may include, for example, a removable storage unit 822 and an interface 820. Examples of the removable storage unit 822 and the interface 820 may include a program cartridge and cartridge interface (such as that found in video game devices), a removable memory chip (such as an EPROM or PROM) and associated socket, a memory stick and USB port, a memory card and associated memory card slot, and/or any other removable storage unit and associated interface.

Computer system 800 may further include a communication or network interface 824. Communication interface 824 may enable computer system 800 to communicate and interact with any combination of external devices, external networks, external entities, etc. (individually and collectively referenced by reference number 828). For example, communication interface 824 may allow computer system 800 to communicate with external or remote devices 828 over communications path 826, which may be wired and/or wireless (or a combination thereof), and which may include any combination of LANs, WANs, the Internet, etc. Control logic and/or data may be transmitted to and from computer system 800 via communication path 826.

Computer system 800 may also be any of a personal digital assistant (PDA), desktop workstation, laptop or notebook computer, netbook, tablet, smart phone, smart watch or other wearable, appliance, part of the Internet-of-Things, and/or embedded system, to name a few non-limiting examples, or any combination thereof.

Computer system 800 may be a client or server, accessing or hosting any applications and/or data through any delivery paradigm, including but not limited to remote or distributed cloud computing solutions; local or on-premises software (“on-premise” cloud-based solutions); “as a service” models (e.g., content as a service (CaaS), digital content as a service (DCaaS), software as a service (SaaS), managed software as a service (MSaaS), platform as a service (PaaS), desktop as a service (DaaS), framework as a service (FaaS), backend as a service (BaaS), mobile backend as a service (MBaaS), infrastructure as a service (IaaS), etc.); and/or a hybrid model including any combination of the foregoing examples or other services or delivery paradigms.

Any applicable data structures, file formats, and schemas in computer system 800 may be derived from standards including but not limited to JavaScript Object Notation (JSON), Extensible Markup Language (XML), Yet Another Markup Language (YAML), Extensible Hypertext Markup Language (XHTML), Wireless Markup Language (WML), MessagePack, XML User Interface Language (XUL), or any other functionally similar representations alone or in combination. Alternatively, proprietary data structures, formats or schemas may be used, either exclusively or in combination with known or open standards.

In some embodiments, a tangible, non-transitory apparatus or article of manufacture comprising a tangible, non-transitory computer useable or readable medium having control logic (software) stored thereon may also be referred to herein as a computer program product or program storage device. This includes, but is not limited to, computer system 800, main memory 808, secondary memory 810, and removable storage units 818 and 822, as well as tangible articles of manufacture embodying any combination of the foregoing. Such control logic, when executed by one or more data processing devices (such as computer system 800), may cause such data processing devices to operate as described herein.

Based on the teachings contained in this disclosure, it will be apparent to persons skilled in the relevant art(s) how to make and use embodiments of this disclosure using data processing devices, computer systems and/or computer architectures other than that shown in FIG. 8. In particular, embodiments can operate with software, hardware, and/or operating system implementations other than those described herein.

It is to be appreciated that the Detailed Description section, and not any other section, is intended to be used to interpret the claims. Other sections can set forth one or more but not all exemplary embodiments as contemplated by the inventor(s), and thus, are not intended to limit this disclosure or the appended claims in any way.

While this disclosure describes exemplary embodiments for exemplary fields and applications, it should be understood that the disclosure is not limited thereto. Other embodiments and modifications thereto are possible, and are within the scope and spirit of this disclosure. For example, and without limiting the generality of this paragraph, embodiments are not limited to the software, hardware, firmware, and/or entities illustrated in the figures and/or described herein. Further, embodiments (whether or not explicitly described herein) have significant utility to fields and applications beyond the examples described herein.

Embodiments have been described herein with the aid of functional building blocks illustrating the implementation of specified functions and relationships thereof. The boundaries of these functional building blocks have been arbitrarily defined herein for the convenience of the description. Alternate boundaries can be defined as long as the specified functions and relationships (or equivalents thereof) are appropriately performed. Also, alternative embodiments can perform functional blocks, steps, operations, methods, etc. using orderings different than those described herein.

References herein to “one embodiment,” “an embodiment,” “an example embodiment,” or similar phrases, indicate that the embodiment described can include a particular feature, structure, or characteristic, but every embodiment can not necessarily include the particular feature, structure, or characteristic. Moreover, such phrases are not necessarily referring to the same embodiment. Further, when a particular feature, structure, or characteristic is described in connection with an embodiment, it would be within the knowledge of persons skilled in the relevant art(s) to incorporate such feature, structure, or characteristic into other embodiments whether or not explicitly mentioned or described herein. Additionally, some embodiments can be described using the expression “coupled” and “connected” along with their derivatives. These terms are not necessarily intended as synonyms for each other. For example, some embodiments can be described using the terms “connected” and/or “coupled” to indicate that two or more elements are in direct physical or electrical contact with each other. The term “coupled,” however, can also mean that two or more elements are not in direct contact with each other, but yet still co-operate or interact with each other.

The breadth and scope of this disclosure should not be limited by any of the above-described exemplary embodiments, but should be defined only in accordance with the following claims and their equivalents.

What is claimed is:

1. A computer implemented method for software threat analysis, comprising:
storing training data and a plurality of promotion rules;
training a first machine learning model using the training data to identify malicious code;
training a second machine learning model using the training data to identify threat protection code;
analyzing an application under test using the first machine learning model to determine a likelihood that the application under test includes malicious code;
analyzing the application under test using the second machine learning model to determine a likelihood that the application under test includes threat protection code; and
promoting or denying promotion of the application under test based on the likelihood that the application under test includes malicious code, the likelihood that the application under test includes threat protection code, and the plurality of promotion rules.

2. The computer implemented method of claim 1, wherein the first machine learning model and the second machine learning model are large language models (LLMs).

3. The computer implemented method of claim 1, further comprising crawling one or more threat intelligence feeds to obtain the training data.

4. The computer implemented method of claim 1, wherein the training data includes connections to rogue domains, digital skimmer scripts, or indicators of compromised payloads.

5. The computer implemented method of claim 1, wherein the training data is stored as a vector database including rogue domain vector embeddings, digital skimmer vector embeddings, or indicators of compromise vector embeddings.

6. The computer implemented method of claim 1, wherein the training data includes content security policies, sub-resource integrity hashes, or HTTP security headers.

7. The computer implemented method of claim 1, wherein the training data is stored as a vector database including content security policy vector embeddings, sub-resource integrity hash vector embeddings, or HTTP security header vector embeddings.

8. A threat analysis system, comprising:
a memory that stores training data and a plurality of promotion rules; and
at least one processor coupled to the memory and configured to:
train a first machine learning model using the training data to identify malicious code;
train a second machine learning model using the training data to identify threat protection code;
analyze an application under test using the first machine learning model to determine a likelihood that the application under test includes malicious code;
analyze the application under test using the second machine learning model to determine a likelihood that the application under test includes threat protection code; and
promote or deny promotion of the application under test based on the likelihood that the application under test includes malicious code, the likelihood that the application under test includes threat protection code, and the plurality of promotion rules.

9. The threat analysis system of claim 8, wherein the first machine learning model and the second machine learning model are large language models (LLMs).

10. The threat analysis system of claim 8, wherein the at least one processor is further configured to crawl one or more threat intelligence feeds to obtain the training data.

11. The threat analysis system of claim 8, wherein the training data includes connections to rogue domains, digital skimmer scripts, or indicators of compromised payloads.

12. The threat analysis system of claim 8, wherein the training data is stored as a vector database including rogue domain vector embeddings, digital skimmer vector embeddings, or indicators of compromise vector embeddings.

13. The threat analysis system of claim 8, wherein the training data includes content security policies, sub-resource integrity hashes, or HTTP security headers.

14. The threat analysis system of claim 8, wherein the training data is stored as a vector database including content security policy vector embeddings, sub-resource integrity hash vector embeddings, or HTTP security header vector embeddings.

15. A non-transitory computer-readable device having instructions stored thereon that, when executed by at least one computing device, cause the at least one computing device to perform operations comprising:
storing training data and a plurality of promotion rules;
training a first machine learning model using the training data to identify malicious code;
training a second machine learning model using the training data to identify threat protection code;
analyzing an application under test using the first machine learning model to determine a likelihood that the application under test includes malicious code;
analyzing the application under test using the second machine learning model to determine a likelihood that the application under test includes threat protection code; and
promoting or denying promotion of the application under test based on the likelihood that the application under test includes malicious code, the likelihood that the application under test includes threat protection code, and the plurality of promotion rules.

16. The non-transitory computer-readable device of claim 15, wherein the first machine learning model and the second machine learning model are large language models (LLMs).

17. The non-transitory computer-readable device of claim 15, wherein the training data includes connections to rogue domains, digital skimmer scripts, or indicators of compromised payloads.

18. The non-transitory computer-readable device of claim 15, wherein the training data is stored as a vector database including rogue domain vector embeddings, digital skimmer vector embeddings, or indicators of compromise vector embeddings.

19. The non-transitory computer-readable device of claim 15, wherein the training data includes content security policies, sub-resource integrity hashes, or HTTP security headers.

20. The non-transitory computer-readable device of claim 15, wherein the training data is stored as a vector database including content security policy vector embeddings, sub-resource integrity hash vector embeddings, or HTTP security header vector embeddings.
